(19) United States
(12) Patent Application Publication
(10) Pub. No.: US 2015/0186624 A1
(43) Pub. Date: Jul. 2, 2015

(54) SYSTEM AND METHOD FOR MANAGING PERSONAL CONTENT COPYRIGHT USING CONTEXT-BASED SEARCH ENGINE

(71) Applicants: Samsung Electronics Co., Ltd., Gyeonggi-do (KR); Areschan Co., LTD., Seoul (KR)

(72) Inventors: Min-Sup LEE, Seoul (KR); Sun-Woo LEE, Gyeonggi-do (KR)

(73) Assignees: Samsung Electronics Co., Ltd.; Areschan Co., LTD.

(21) Appl. No.: 14/584,713

(22) Filed: Dec. 29, 2014

(30) Foreign Application Priority Data
Dec. 27, 2013 (KR) 10-2013-0164870

(51) Int. Cl. G06F 21/10; G06F 17/30

(52) U.S. Cl. CPC G06F 21/105; G06F 17/30864; G06F 17/30943

(57) ABSTRACT

A system and a method for managing a personal content copyright using a context-based search engine is provided. The system is connected to a copyright owner terminal through a communication network and includes a web server and a database server. The web server receives contents as contents to be managed and policy information, from the copyright owner terminal, extracts a feature point of the contents to be managed, according to a type of the contents to be managed, and registers the feature point of the contents to be managed. The database server stores the feature point of the contents to be managed and the policy information.

### PRIORITY

This application claims priority under 35 U.S.C. §119(a) to Korean Patent Application Serial No. 10-2013-0164870, filed in the Korean Intellectual Property Office on Dec. 27, 2013, the entire content of which is incorporated herein by reference.

### BACKGROUND OF THE INVENTION

1. Field of the Invention

The present invention relates generally to a system and a method for managing a personal content copyright using a context-based search engine to protect a copyright of personal contents circulated in a wired/wireless communication network.

2. Description of the Related Art

According to the development of Internet technologies, the diversification of distribution channels for media content, and the expansion of multimedia content suppliers and consumers, digital content has consolidated its place as an independent product. Various types of content such as music, movies, broadcasts, publications, games and the like are circulated through various means of on and off-line companies, and the amount of circulation thereof has increased every year.

Further, User Created Content (UCC) and images directly produced by communication network users are circulated through communication networks so that content produced by individual users can be read and downloaded by other people over the communication networks.

Although copyright rights of such user created content are generally reserved by the creator of the content as intangible properties, such content is often illegally distributed, circulated, downloaded, shared, and copied over communication networks, so that frequent infringements on the producer's rights are increasing. Further, due to the characteristics of communication networks, it is difficult to monitor whether copyrighted content is circulated, and moreover, there is a limitation on punishing every illegal user since there are often a vast number of illegal users.

In addition, when data is transformed, the identity of the data cannot be easily recognized, and thus it is difficult to prevent users from using illegally acquired content. Accordingly, it is difficult for copyright owners to exercise their rights to their user created content, and thus, their property rights are damaged.

### SUMMARY

The present invention has been made to address at least the problems and disadvantages described above, and to provide at least the advantages described below. Accordingly, an aspect of the present invention is to provide a system and a method for managing contents which extract and register a feature point of content data of a copyright owner, identify a copyright through a feature point matching technique to determine whether content similar to the managed copyrighted content are circulated, and provide a result of the determination to the copyright owner, so as to prevent illegal circulation of content.

In accordance with an aspect of the present invention, a system for managing a personal content copyright using a context-based search engine is provided. The system includes a web server that receives contents as contents to be managed and policy information, from the copyright owner terminal, extracts a feature point of the contents to be managed, according to a type of the contents to be managed, and registers the feature point of the contents to be managed; and a database server that stores the feature point of the contents to be managed and the policy information.

In accordance with another aspect of the present invention, a method of managing a personal content copyright using a context-based search engine and a personal content copyright management system is provided. The method includes receiving contents as contents to be managed and policy information, from a copyright owner terminal, extracting a feature point of the contents to be managed, according to a type of the contents to be managed, registering the feature point of the contents to be managed, receiving partial data of used contents, from a plurality of web hard servers and a plurality of user terminals, when contents are used, extracting a feature point of the partial data of the used contents, comparing the feature point of the partial data of the used contents with the registered feature points of the contents to be managed to search for matching contents to be managed extracting policy information of the matching contents to be managed; transmitting the extracted policy information of the matching contents to be managed to a corresponding web hard server and user terminal, and notifying a copyright owner of the matching contents to be managed that the contents to be managed have been used.

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates a personal content copyright management system, according to an embodiment of the present invention;

FIG. 2 is a block diagram of an internal configuration of a personal content copyright management system, according to an embodiment of the present invention;

FIG. 3 is a flowchart illustrating a method of extracting a feature point of image contents, according to an embodiment of the present invention;

FIG. 4 illustrates a method of generating an OSID signature, according to an embodiment of the present invention;

FIG. 5 illustrates a method of vector quantization, according to an embodiment of the present invention;

FIG. 6 illustrates a method of extracting a feature point of sound source contents, according to an embodiment of the present invention;

FIG. 7 is a flowchart illustrating a method of managing a personal content copyright, according to an embodiment of the present invention;

FIG. 8 illustrates a method of extracting a feature point of partial data of received image contents, according to an embodiment of the present invention; and

FIGS. 9 and 10 illustrate a method of matching image contents, according to an embodiment of the present invention.

### DETAILED DESCRIPTION OF EMBODIMENTS OF THE PRESENT INVENTION

Hereinafter, various embodiments of the present invention will be described more specifically with reference to the accompanying drawings. However, it should be understood that the present invention is not limited to the specific embodiments, but the present disclosure includes all modifications, equivalents, and alternatives within the spirit and the scope of the present invention. Although the terms “ordinal numbers” such as first, second and the like are used to describe various structural elements, the structural elements should not be defined by the terms. The terms are only used to distinguish one element from another element. For example, without departing from the scope of the present invention, a first structural element may be named a second structural element. Similarly, the second structural element also may be named the first structural element.

In the present invention, the terms are used to describe a specific embodiment, and are not intended to limit the present invention. As used herein, the singular forms are intended to include the plural forms as well, unless the context clearly indicates otherwise. In the specification, it should be understood that the terms “include” and “have” indicate existence of a feature, a number, a step, an operation, a structural element, parts, or a combination thereof, and do not previously exclude the existence or probability of addition of one or more other features, numbers, steps, operations, structural elements, parts, or combinations thereof.

According to an embodiment of the present invention, a personal content copyright using a context-based search engine can easily register contents produced by an individual user and thus prevent the copyrighted contents from being illegally circulated over a communication network, thereby effectively protecting a personal content copyright owner's right. According to an embodiment of the present invention, a copyright identifying technique is provided through the use of a content feature point matching technique. Accordingly, even if a content user changes attributes of the corresponding contents, or changes or edits a data format so as not to provide royalties, the present invention can accurately identify the use of the corresponding contents and thus the copyright owner can determine if the contents are being circulated and react accordingly, thereby minimizing property damage to the content copyright owner.

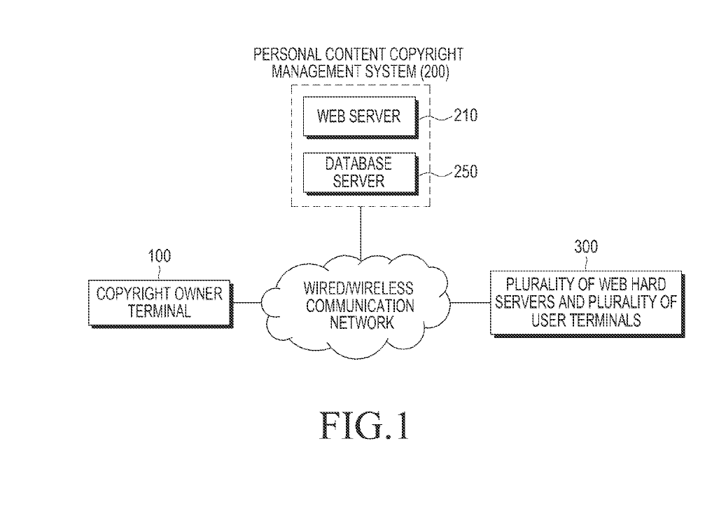

FIG. 1 illustrates a configuration of a personal content copyright management system, according to an embodiment of the present invention.

Referring to FIG. 1, a personal content copyright management system 200 is connected with a copyright owner terminal 100 through a wired/wireless communication network. The personal content copyright management system 200 receives one or more contents from the copyright owner terminal 100 as contents to be managed, extracts a feature point according to the type of contents, registers the feature point of the contents to be managed, receives content policy information containing attribute information of the corresponding contents, copyright owner information, information about the possibility of sharing of the contents, and charging information, and registers the received content policy information.

Accordingly, in order to identify a personal content copyright, the personal content copyright management system 200 registers and manages only the feature point without the need to store all content data, so that there is no burden in a storage space and a search can be performed at a high speed. Further, a content user matches feature points of content data rather than using attribute information such as metadata of contents of which information can be easily changed. Accordingly, even when the content user changes attributes of the corresponding contents to not provide royalties, the corresponding contents can be accurately searched for.

Further, the personal content copyright management system 200 is connected with a plurality of web hard servers and a plurality of user terminals 300 through a wired/wireless communication network. When contents are used, the personal content copyright management system 200 automatically receives partial data of corresponding used contents, extracts a feature point, and compares the extracted feature point with a feature point of contents to be managed. When the contents to be used is the contents to be managed, the personal content copyright management system 200 transmits policy information of the corresponding contents to the corresponding web hard server and user terminal 300, which uses the contents, and also transmits to the copyright owner terminal 100, by message, notification that the contents have been used. Accordingly, it is possible to prevent copyrighted contents, which have been registered in the personal content copyright management system 200, from being illegally circulated over a communication network and to effectively protect a right of a personal content copyright owner.

In addition, although not illustrated, the present invention may further include an electronic payment system which is connected with the plurality of web hard servers and the plurality of user terminals 300 and can be linked with the personal content copyright management system to allow the plurality of web hard servers and user terminals 300 to make an electronic payment using a credit card, Internet banking, electronic money, mobile phone authentication and the like.

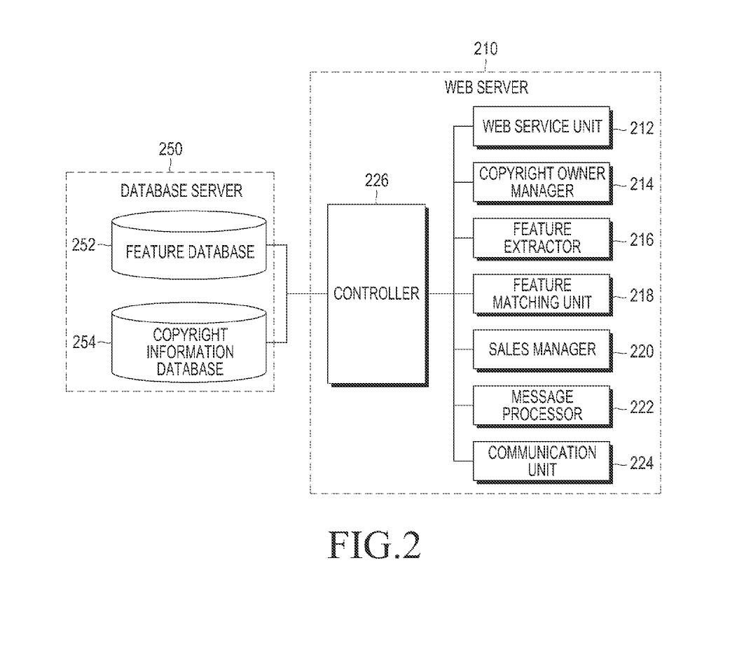

The personal content copyright management system 200 provides a service by which the copyright owner can register both the contents and policy information of the corresponding contents in a web browser form, extracts a feature point according to the type of contents received from the copyright owner terminal 100, and registers the received contents as contents to be managed. Further, when the plurality of web hard servers and the plurality of user terminals 300 use the contents, the personal content copyright management system 200 automatically receives partial data of the contents to be used, extracts a feature point, and compares the extracted feature point with a feature point of the contents to be managed. When the contents to be used correspond to the contents to be managed, the personal content copyright management system 200 transmits policy information of the corresponding contents to the corresponding web hard server and user terminal 300 and also transmits to the copyright owner terminal 100, by message, notification that the contents have been used. To this end, the personal content copyright management system 200 is configured to include a web server 210 and a database server 250 and a detailed configuration of the personal content copyright management system will be described in more detail with reference to FIG. 2 below.

FIG. 2 is a block diagram of an internal configuration of a personal content copyright management system, according to an embodiment of the present invention.

Referring to FIG. 2, the personal content copyright management system 200 includes the web server 210 and the database server 250. The web server 210 includes a web service unit 212, a copyright owner manager 214, a feature extractor 216, a feature matching unit 218, a sales manager 220, a message processor 222, a communication unit 224, and a controller 226. The database server 250 includes a feature database 252 and a copyright information database 254.

The web service unit 212 provides a service by which a copyright owner terminal 100 accessing through a wired/wireless network can register its own contents using a web browser form.

The copyright owner manager 214 identifies the identity of a copyright owner, and stores and manages the copyright information database 254 which stores unique information of the copyright owner who desires to use the personal content copyright management service 200. When a new copyright owner accesses the personal content copyright management service 200 and makes a request for membership, the copyright owner manager 214 generates a new database in the copyright information database 254.

The feature extractor 216 extracts a feature point of the contents. A method of extracting the feature point varies depending on the type of contents. In an embodiment of the present invention, when the type of contents corresponds to image data, a histogram is generated by extracting a frame signature from each frame of the image and performing vector quantization through a codebook. Further, when the type of contents corresponds to sound source data, a Fast Fourier Transform (FFT) is performed on every frame of original or query data, and thus, a feature point is generated by a combination of Frequency (F) and Time stamp (T). When the type of contents corresponds to text data, a hash value of a block corresponding to a length of a pattern in text is generated as a feature point through a Rabin-Karp algorithm, for example.

When the contents are used by the plurality of web hard servers and the plurality of user terminals 300 the feature matching unit 218 compares the feature point extracted from the partial data transmitted for the contents to be used with the contents which are to be managed and registered in the feature database 252. In this way, it can be determined whether the contents to be used correspond to the contents to be managed.

The method for matching the content feature points varies depending on the type of contents. In an embodiment of the present invention, when the type of contents corresponds to image contents the feature matching unit 218 uses histogram binarization to calculate a hamming distance between binary strings of a histogram extracted from the feature extractor 215 and a histogram stored in the feature database 252. When the hamming distance is larger than a preset threshold, the feature matching unit 218 calculates histogram intersection and first selects a segment larger than a threshold from segments stored in the feature database 252. Subsequently, the feature matching unit 218 performs a similarity matrix between all frame signatures included in respective segments having passed through the histogram matching to search for matching image contents.

When the type of contents corresponds to sound source data, the feature matching unit 218 determines contents having equal feature points and a larger number of pieces of data having an equal time difference according to a time location of the feature point as contents having high similarity and searches for matching sound source contents based on the determination

When the type of contents corresponds to text data, the feature matching unit 218 searches for the matching text contents through a comparison of a hash value of a block corresponding to a length of a pattern in text by using, for example, a Rabin-Karp algorithm. That is, the feature matching unit 218 determines the similarity by calculating the hash value of the block while moving a position from 0 corresponding to the beginning of the text to 0.

For the contents which the plurality of web hard servers and the plurality of user terminals 300 desire to use, the sales manager 220 searches for policy information in the copyright information database 254 through the feature matching unit 218 and transmits the found policy information to the corresponding web hard server and user terminal.

When contents which are to be managed and are registered in the system are used by the plurality of web hard servers and the plurality of user terminals 300, the message processor 222 notifies the corresponding copyright owner of the use. To this end, the message processor 222 transmits the content informing of the use of the contents registered by the copyright owner in the form of a popup, a notification, a note, or a SMS message.

The communication unit 224 provides a network interface for performing wired/wireless communication with the copyright owner terminal 100 and the plurality of web hard servers and the plurality of user terminals 300.

The controller 226 extracts a feature point of the contents to be registered in the personal content copyright management system 200 by the copyright owner terminal 100 through the feature extractor 216, registers the contents as contents to be managed in the feature database 252, receives policy information containing attribute information of the corresponding contents, copyright owner information, information about the possibility of sharing the contents, charging information and the like from the copyright owner, and stores the received policy information in the copyright information database 254. In order to identify whether the contents to be registered by the copyright owner are purely creative contents to which a copyright can be assigned, the controller 226 compares the feature point of the contents to be registered with feature points pre-stored in the feature database 252 through the feature matching unit 218 to identify whether the contents are purely creative contents.

Further, the controller 226 extracts, through the feature extractor 216, a feature point from partial data of the used contents transmitted through the communication unit 224 when the plurality of web hard servers and the plurality of user terminals 300 use the contents, matches the contents with contents registered in the feature database 252, through the feature matching unit 218, and compares the contents to be used with the contents to be managed. When the contents to be used correspond to the contents to be managed, based on a result of the comparison, the controller 226 transmits policy information of the corresponding contents to the corresponding web hard server or user terminal and transmits t to the copyright owner terminal 100, through the message processor 222, notification that the contents have been used.

The feature database 252 of the database server 250 stores the feature point of the contents extracted through the feature extractor 216.

The copyright information database 254 stores policy information such as content attribute information, which the copyright owner sets with respect to the contents registered in the feature database 252, copyright owner information, information about the possibility of sharing of the contents, charging information, and the like. The copyright information database 254 may include various pieces of information such as unique information including a name and a contact number of the copyright owner, content attribute information including a title, a version, and a reproduction time, a selling price, a selling condition, and the like, according to a setting by the copyright owner.

Hereinafter, a personal content copyright management service method according to an embodiment of the present invention will be described using the personal content copyright management system 200 configured as described above.

First, in order to perform the personal content copyright management service method according to the present invention, the copyright owner registers his or her own contents in the personal content copyright management system 200. At this time, a feature point of the contents is extracted based on the type of contents. The extracted feature point is registered in the feature database 252 as the feature point of the contents to be managed. In addition, content policy information such as attribute information of the corresponding contents, copyright owner information, information about the possibility of sharing of the contents, charging information, and the like is transmitted and registered, according to a setting by the copyright owner.

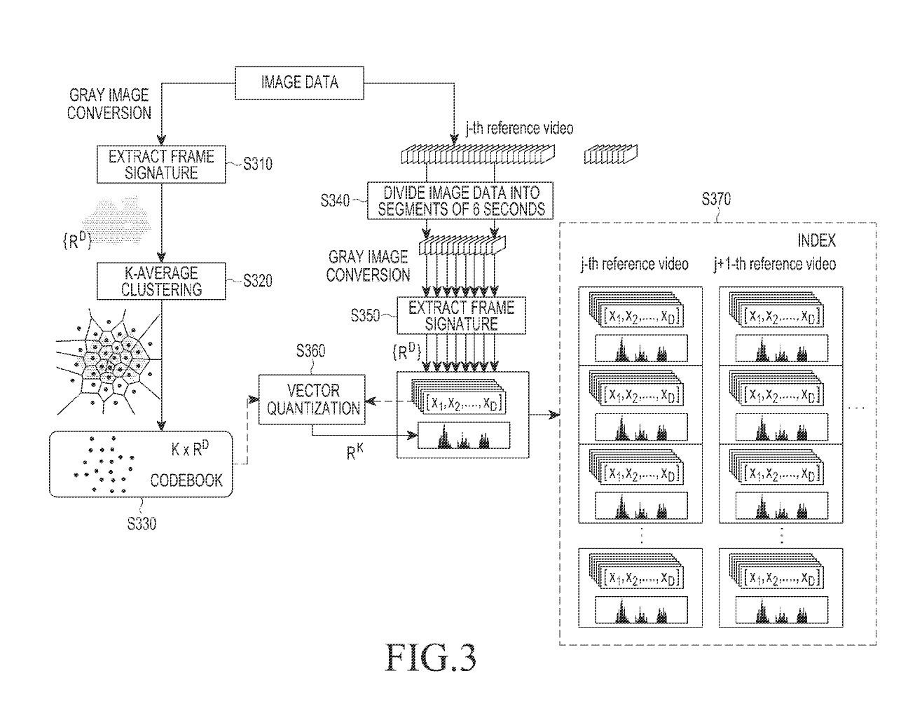

To this end, a process of extracting the feature point based on the type of contents will be described with reference to FIGS. 3 to 6.

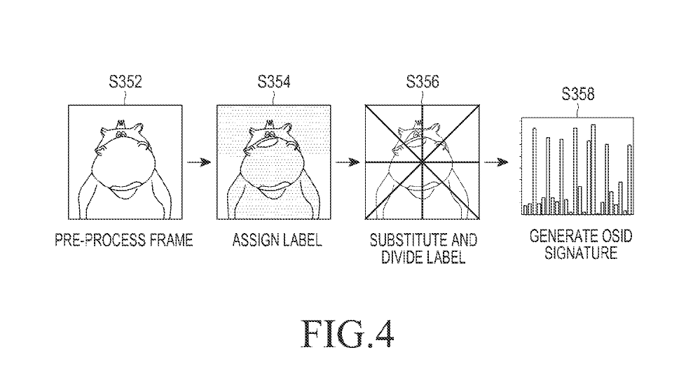

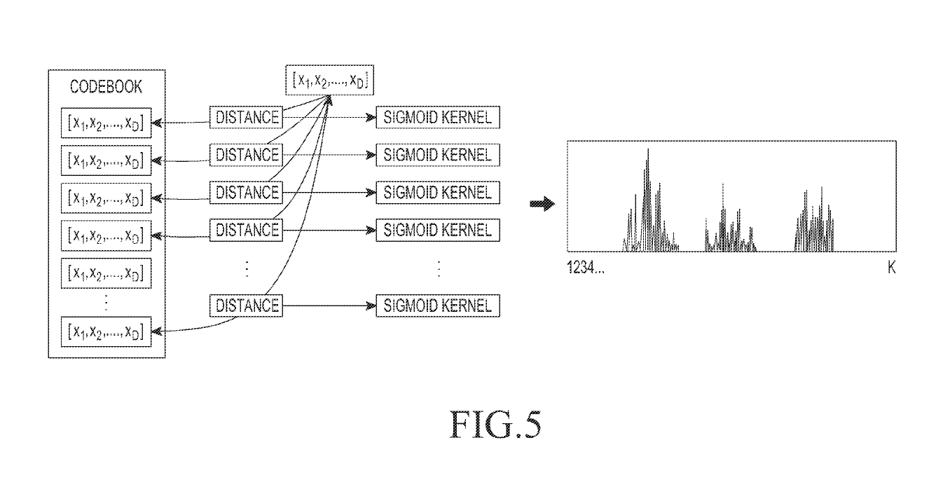

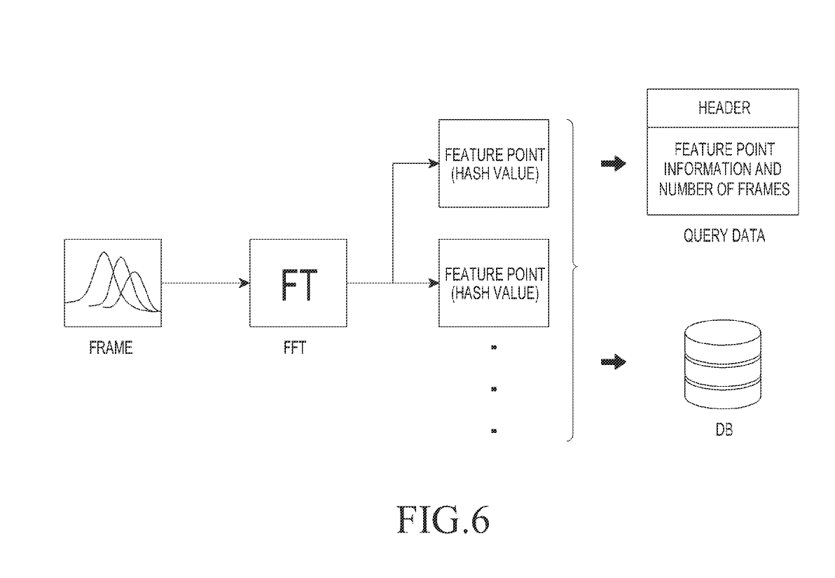

FIG. 3 is a flowchart illustrating a method of extracting a feature point of image contents; FIG. 4 illustrates a method of generating an OSID signature; FIG. 5 illustrates a method of vector quantization; FIG. 6 illustrates a method of extracting a feature point of sound source contents, according to an embodiment of the present invention. Referring to FIG. 3, the feature extractor 216 first converts image data received from the copyright owner terminal 100 into a gray image, extracts a frame signature from a frame of the converted image data in step S310, and calculates K feature vectors (Centroid) in a frame signature vector space with respect to the extracted frame signatures through K-average clustering in step S320. Subsequently, the K feature vectors are assigned orders from 1 to K and form a codebook in step S330.

Next, the feature extractor 216 divides the image data into segments having a preset interval to calculate partial information of the image data in step S340 and extracts a frame signature from frames included in each segment in step S350. It is preferable that an interval between the segments is a minimum of 6 seconds, and the image is normalized to N*N to be strong on a resolution conversion after being converted into the gray image which is strong on a saturation conversion.

There are various types of signatures but it is preferable to use an Ordinal Spatial Intensity Distribution (OSID) descriptor.

Referring to FIG. 4, the feature extractor 216 acquires a signature for expressing one frame by calculating a D dimensional feature vector from the normalized N*N image. To this end, as illustrated in FIG. 4, the feature extractor arranges all pixels of the N*N gray image in an order of brightness in step S352, divides the arranged list into m groups, and assigns labels from 0 to m−1 to the respective groups in step S354. Subsequently, the feature extractor 216 substitutes a group label including a brightness value of the pixel for each pixel and divides the image at an interval of 45 degrees, based on the center of the image in step S356. Next, the feature extractor generates a histogram of a label value in each sub region and generates an OSID signature of one frame by connecting eight histograms in step S358.

Referring back to FIG. 3, in such a way, vector quantization is performed by the feature vectors of the codebook previously formed with respect to the extracted frame signatures in step S360.

Referring to FIG. 5, the vector quantization is performed by Equation (1) below using a Sigmoid Kernel function

$$y \text{?}$$

$$\text{?} \text{indicates text missing or illegible when filed}$$

to apply smoothness when a distance |w−x| between a feature vector w of the codebook and a frame signature s is accumulated in the histogram.

Accordingly, referring back to FIG. 3, the histogram in which feature vectors of the codebook are accumulated is generated and segment information including signatures and the histogram is inserted into an index in step S370.

$$h \text{?} \\ \text{?} \text{indicates text missing or illegible when filed} \qquad ( 1 )$$

In Equation (1), |w₁−x| denotes a distance between an i^{th} feature vector of the codebook and x, and Vx^{f}−Q denotes all frame signatures included in the query.

Referring to FIG. 6, in a case of the sound source contents, a feature point is extracted from original or query data by performing a Fast Fourier Transform (FFT) on each frame. The query data contains header information including brief information (number of pieces of feature point information and number of frames) on the extracted feature point (hash value) and feature point information. Accordingly, the feature database 252 stores information, including the extracted feature point and metadata of the sound source contents and the feature point is used for a search and the metadata is used for transmitting a result.

In the case of the text contents, a hash value of a block corresponding to a length of a pattern in the text is generated as a feature point by using a Rabin-Karp algorithm.

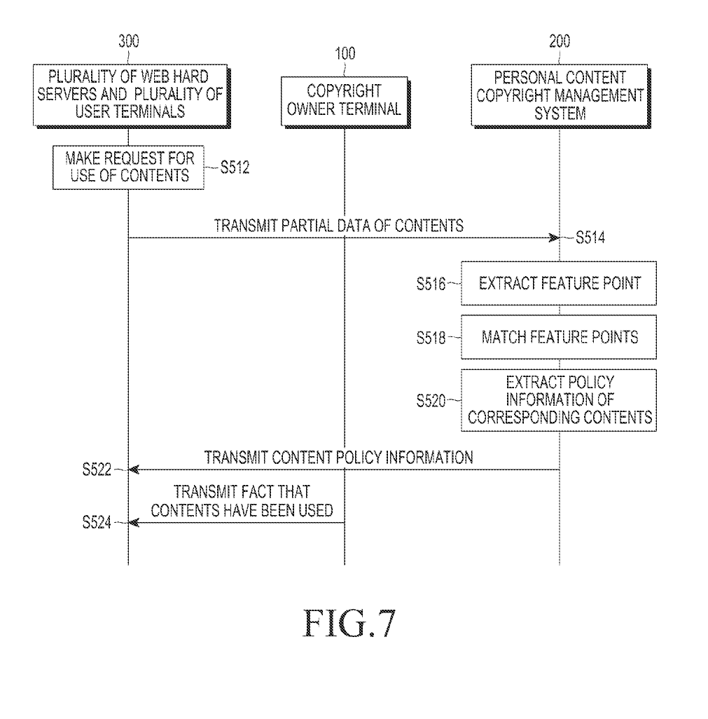

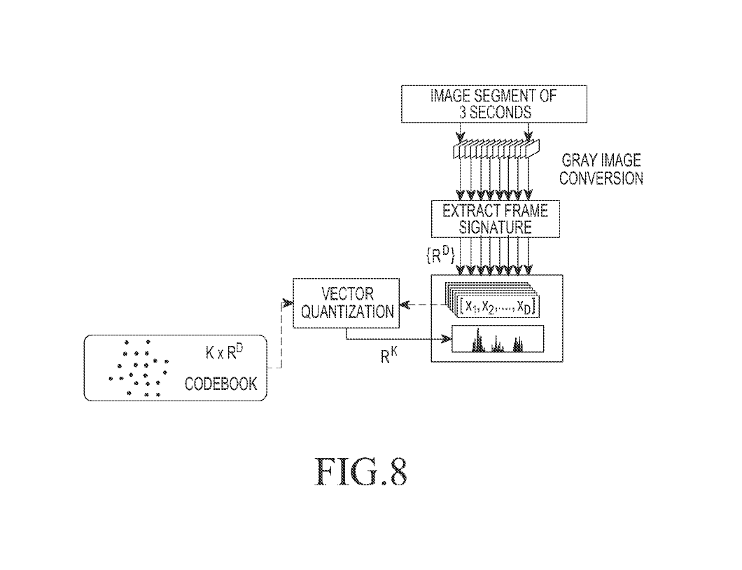

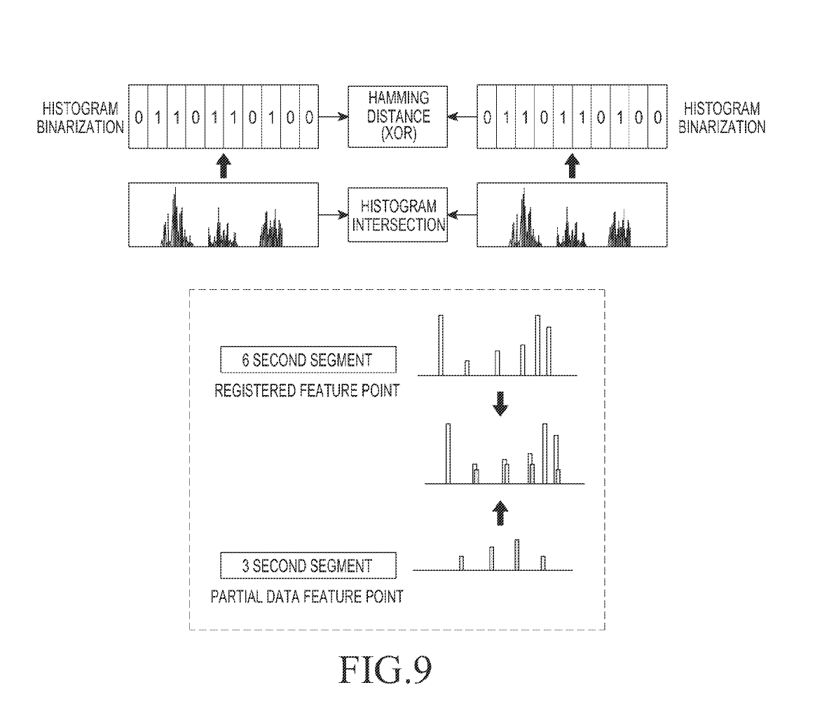

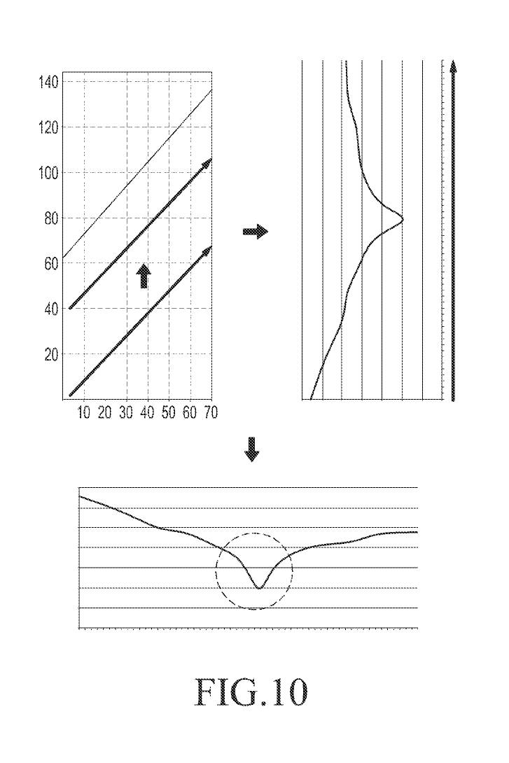

FIG. 7 is a flowchart illustrating a personal content copyright management method; FIG. 8 illustrates a method of extracting a feature point of partial data of received image contents; FIGS. 9 and 10 illustrate a method of matching image contents, according to an embodiment of the present invention.

Referring to FIG. 7, when the plurality of web hard servers and the plurality of user terminals 300 use contents in step 512, the web server 210 of the personal content copyright management system 200 automatically receives partial data of the corresponding used contents in step S514.

When the contents received from the plurality of web hard servers and the plurality of user terminals 300 correspond to sound source data, the web server 210 preferably receives the sound source data having a reproduction time of 3 seconds or longer. When the contents correspond to image data, the web server 210 preferably receives the image data having a reproduction time between 3 seconds and 6 seconds. When the contents correspond to text data, the web server 210 preferably receives the text data having at least 10 sentences based on a new line character of the sentence.

Subsequently, the web server 210 extracts a feature point from partial data of the received used contents in step S516.

Referring to FIG. 8, when the type of contents corresponds to image contents, the web server 210 extracts frame signatures from each frame of the 3 second image and performs vector quantization through a codebook, so as to generate a histogram as illustrated in FIG. 8. The step of extracting the frame signatures and generating the histogram through the codebook is the same as the method in which the feature extractor 216 extracts the feature point of the image contents described in FIG. 3. Further, when the type of contents corresponds to sound source data, the web server 210 extracts the feature point by a combination of Frequency (F) and Time stamp (T) by performing a Fast Fourier Transform (FFT) on each frame of original or query data. When the type of contents corresponds to text data, the web server 210 extracts a hash value of a block corresponding to a length of a pattern in the text as the feature point by using a Rabin-Karp algorithm.

Next, referring back to FIG. 7, the web server 210 compares the extracted feature point with a feature point of contents which are to be managed, stored in the feature database 252 to identify whether the contents to be used correspond to the contents to be managed in step S518.

Referring to FIG. 9, when the type of contents corresponds to image contents, the feature matching unit 218 calculates a hamming distance between binary strings of a histogram extracted from the feature extractor 216 and a histogram stored in the feature database 252 through the histogram binarization, as illustrated in FIG. 9. When the hamming distance is larger than a preset threshold, the web server 210 calculates histogram intersection and first selects a segment larger than a threshold from segments stored in the feature database 252.

Subsequently, the feature matching unit 218 performs a similarity matrix between all frame signatures included in respective segments having passed through the histogram matching to search for matching image contents.

Referring to FIG. 10, the feature matching unit 218 calculates an accumulated value while scanning a straight line having a preset slope on the similarity matrix and detects a peak on an accumulated curved line. Then, the detected peak becomes a matching pair.

Further, when the type of contents corresponds to sound source contents, the feature matching unit 218 determines contents having equal feature points and a larger number of pieces of data having an equal time difference, according to a time location of the feature point as contents having high similarity and searches for matching sound source contents based on the determination. When the type of contents corresponds to text contents, the feature matching unit 218 searches for matching text contents through a comparison of a hash value of a block corresponding to a length of a pattern in text by using a Rabin-Karp algorithm.

Referring back to FIG. 7, as a result of the identification, when the partial contents received from the plurality of web servers and the plurality of user terminals 300 are contents to be managed, the personal content copyright management system 200 transmits policy information of the corresponding contents to the plurality of web servers and the plurality of user terminals 300, in step S522, and also transmits to the copyright owner terminal, notification that the contents have been used to the copyright owner, in step S524.

As described above, the personal content copyright management system 200 and method using the context-based search engine, according to the present invention, easily register the copyright of contents produced by an each individual, and accordingly, prevents the contents having a copyright from being illegally circulated in a communication network, so as to effectively protect a right of a personal content copyright owner.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A system for managing a personal content copyright using a context-based search engine, the system being connected with a copyright owner terminal through a communication network, the system comprising:
a web server configured to
receive contents as contents to be managed and policy information, from the copyright owner terminal,
extract a feature point of the contents to be managed, according to a type of the contents, and
register the feature point of the contents to be managed; and
a database server configured to stores the feature point of the contents to be managed and the policy information.

2. The system of claim 1, wherein the type of contents includes image data, sound source data, and text data.

3. The system of claim 1, wherein the policy information includes attribute information of the corresponding contents to be managed, copyright owner information, information related to a possibility of sharing the contents to be managed, and charging information.

4. The system of claim 1, wherein the web server is connected with a plurality of web hard servers and a plurality of user terminals through a communication network and, when contents are used, the web server is further configured to
automatically receive partial data of used contents,
extract a feature point of the partial data of used contents, and
compare the feature point of the partial data of the used contents with registered feature points of the contents to be managed.

5. The system of claim 4, wherein, when the feature point of the partial data of the used contents corresponds to the feature point of the contents to be managed, based on a result of the comparison, the web server transmits the policy information of corresponding contents to be managed to a web hard server and user terminal.

6. The system of claim 4, wherein, when the feature point of the partial data of the used contents corresponds to the feature point of the contents to be managed, the web server notifies the copyright owner terminal of corresponding contents to be managed that the contents to be managed have been used.

7. The system of claim 1, wherein the web server comprises:
a web service unit configured to provide a service through which a copyright owner can register the contents as the contents to be managed and the policy information, in a web browser form;
a copyright owner manager configured to perform copyright owner authentication;
a feature extractor configured to extract a feature point of contents;
a feature matching unit configured to compare the feature point extracted by the feature extractor with pre-registered feature points to search for matching contents;
a sales manager configured to transmits the policy information to a plurality of web hard servers and a plurality of user terminals;
a message processor configured to notify the copyright owner terminal that the contents have been used;
a communication unit configured to perform communication with the copyright owner terminal and the plurality of web hard servers and the plurality of user terminals; and
a controller configured to
control the feature extractor to extract the feature point of the contents to be managed, registers the feature point of the contents to be managed, extract a feature point of the partial data of used contents, which is transmitted from the plurality of web hard servers and the plurality of user terminals, when the contents are used,
control the feature matching unit to compare the feature point of the partial data of the used contents with the feature point of the contents to be managed, and
control the message processor unit to transmit the policy information of corresponding contents to be managed to a corresponding web hard server and user terminal when the feature point of the partial data of the used contents corresponds to the feature point of the contents to be managed, based on a result of the comparison, and notify a copyright owner terminal of the corresponding contents to be managed that the contents to be managed have been used.

8. The system of claim 1, wherein the database server comprises:
a feature database configured to store the feature point of the contents to be managed; and
a copyright information database configured to store the policy information of the contents to be managed.

9. The system of claim 7, wherein, when the type of contents correspond to image data, the feature extractor is further configured to extract a frame signature from each frame of the image data and perform vector quantization through a codebook, so as to generate a histogram.

10. The system of claim 9, wherein the frame signature is extracted after the image data is converted into a gray image which is strong on a saturation conversion.

11. A method of managing a personal content copyright using a context-based search engine and a personal content copyright management system, the method comprising:
receiving contents as contents to be managed and policy information, from a copyright owner terminal;
extracting a feature point of the contents to be managed, according to a type of the contents;
registering the feature point as contents to be managed;
receiving partial data of used contents, from a plurality of web hard servers and a plurality of user terminals, when contents are used;
extracting a feature point of the partial data of the used contents;
comparing the feature point of the partial data of the used contents with registered feature points of the contents to be managed to search for matching contents to be managed;
extracting policy information of the matching contents to be managed;
transmitting the extracted policy information of the matching contents to be managed to a corresponding web hard server and user terminal; and
notifying a copyright owner of the matching contents to be managed that the contents to be managed have been used.

12. The system of claim 11, wherein the type of contents includes image data, sound source data, and text data.

13. The method of claim 11, wherein the policy information includes attribute information of the corresponding contents to be managed, copyright owner information, information related to a possibility of sharing the contents to be managed, and charging information.

14. The method of claim 11, wherein, when the contents correspond to image data, extracting the feature point comprises extracting a frame signature from each frame of the image data and performing vector quantization through a codebook, so as to generate a histogram.

15. The method of claim 14, wherein the frame signature is extracted after the image data is converted into a gray image which is strong on a saturation conversion.

16. The method of claim 14, wherein the codebook is formed by k feature vectors having orders from 1 to k, and the k feature vectors are obtained from frame signatures extracted from frames of the image data through k-average clustering in a frame signal vector space.

17. The method of claim 11, wherein, when the type of contents correspond to sound source data, extracting the feature point comprises generating the feature point from original or query data by a combination of Frequency (F) and Time stamp (T) by performing a Fast Fourier Transform (FFT) in each frame.

18. The method of claim 11, wherein, when the type of contents correspond to text data, extracting the feature point comprises generating, through a Rabin-Karp algorithm, a hash value of a block corresponding to a length of a pattern in text as the feature point.

19. The method of claim 11, wherein registering the feature point of the contents to be managed comprises comparing the feature point of the contents to be managed with pre-registered contents to be managed to determine whether the feature point corresponds to purely creative contents.

20. The method of claim 11, wherein, when the type of the contents correspond to sound source data, receiving the partial data of the used contents comprises receiving sound source data having a reproduction time of 3 seconds or longer.
